(19) United States
(12) Patent Application Publication
(10) Pub. No.: US 2012/0157094 A1
(43) Pub. Date: Jun. 21, 2012

(54) OPTIMAL MANAGEMENT OF CALLS BETWEEN NATIONAL CELLULAR MOBILE TELEPHONE NETWORKS.

(76) Inventors: Kwok Kuen Cheng, Saint Germain En Laye (FR); Marco Fratti, Saint Germain En Laye (FR)

(21) Appl. No.: 13/391,470

(22) PCT Filed: Aug. 16, 2010
(86) PCT No.: PCT/FR2010/051718

§ 371 Date: Mar. 6, 2012

(30) Foreign Application Priority Data
Aug. 21, 2009 (FR) 0955727
Jan. 29, 2010 (FR) 1050630
Apr. 27, 2010 (FR) 10 53231

(51) Int. Cl. H04W 40/02; H04W 8/04; H04W 8/06; H04W 60/00

(52) U.S. Cl. 455/433; 455/445; 455/435.1

(57) ABSTRACT

A method of providing interconnection services, characterized in that it links an assembly of national cellular networks (601, 602) to an interconnection network by gateway servers (201, 202, 301, 302) which are driven by a central routing server (500) so as to establish a global communications network between mobile telecommunication devices (101, 102) such as mobile telephones; an application module (111, 112) which allows a dialog between each mobile telecommunication device (101, 102) and the central routing server (500) is hosted on the mobile telecommunication device (101, 102) of each user.

The subject of the present invention is a method and device allowing optimal management of calls between national mobile telephony cellular networks.

It is known that world growth in the demand for mobile communications has created the need for global roaming services (roaming designating the ability of users to access their mobile telephone services from the cellular network of a foreign country) which enables all users to remain contactable everywhere in the world. Roaming services particularly require agreements between the operators concerned, so that a cell phone subscriber when visiting a different country is able to benefit from the same mobile services provided by the operator in the home country.

For example, if the case is taken of a subscriber with a cell operator of network X in a country A, when roaming on network Y of a country B and wishing to place a call to a person who is also a subscriber with the cell operator of network X in country A, the cost of the call is then the sum of the three following elements:

1. The cost of setting up the outgoing international call on network Y of the visited country B; this is defined by the operator of the visited network Y in relation to roaming agreements between this operator and the operator of network X in country A.

2 The cost of call termination on network X of country A; this is defined by the operator of network X.

3. The interconnection cost i.e. the transport of signalling and call data between the network Y of the visited country B and the network X of the home country A; this is defined by the interconnection operator.

For the caller in roaming situation, all these three costs may be very high.

Again as an example, in a second case in which the subscriber roaming in country B on network Y receives a call, this call is placed by a caller in his home country A, the price to be paid is then composed of the two following elements:

1. The interconnection cost i.e. the transport of signalling and call data between network X of country A and network Y of the visited country B. This cost is defined by the interconnection operator.

2. The cost of call termination on network Y of the visited country B. This cost is defined by the operator of network Y.

In addition, to minimize the costs of roaming communications, increasingly more travellers in the visited country purchase and use SIM cards (Subscriber Identity Module) of prepaid and rechargeable type. With a local SIM card of the visited country the traveller is able to make international calls at a more advantageous rate than roaming prices and is able to receive calls free of charge irrespective of their origin.

It is to be specified that, in principle, a call received by a subscriber on his home network (even in prepaid mode) is always free of charge with the exception of some countries, and that an international call made from this home network is always cheaper than a roaming international call made on a foreign network.

The major drawback with replacing the home SIM card with a local SIM card of the visited country is the loss of identity of the user who can no longer be contacted on his home number, and the user no longer has access either to personal data contained on his home SIM card.

It is more particularly the objective of the invention to solve these problems by proposing the deployment of an intelligent roaming service above the different national cellular networks. This service offers users several advantages:

1. The user is located at the place where he is; in all the countries in which this service is deployed the user can be contacted via the number of his home mobile telecommunication device;

2. The user keeps the content of his home SIM card, mainly the directory;

3. The user optimizes the costs of his communications independently of where he is located, irrespective of the type of SIM used, local SIM of the visited country or home SIM of the country of residence. This cost reduction factor in some cases can represent savings of more than 60% compared with usual roaming price rates.

To achieve this result, the implementing of the invention results in the setting up of a global communications network between mobile telecommunication devices such as mobile telephones. This network consists of an assembly of national cellular networks linked to an interconnection network via gateway servers which are guided by a central routing server associated with a database which manages access rights to the interconnection network of users, and the user who may be a subscriber hosting on his mobile telecommunication device (or mobile telecommunication devices) an application module allowing dialogue between his mobile telecommunication device and the central routing server device—the users' database.

The present invention therefore concerns a method for providing interconnection services characterized by the implementing of the following steps:
subscription of the user to a global roaming service in his home country in which the user has a subscription giving access to the home cell network;
hosting an application module on the user's mobile telecommunication device, the user keeping his subscription to the home cell network and his home SIM card;
providing the user when travelling in a foreign country—by an operator of the global roaming service—with a local or continental SIM card or a multi-identifier SIM card which comprises the identifier of the home SIM, to be noted that the multi-identifier SIM is intended to overcome the disadvantage of having and managing as many local SIM cards as countries frequently visited;
chaining the local or continental SIM number in use onto the home number of the user in the routing server;
if a multi-identifier SIM is used, the chaining of the identifier number used in a visited country onto the home number of the user also takes place in the routing server.

Therefore on each arrival in a visited country, the mobile telecommunication device verifies the identifier of the SIM used and automatically carries out registration with a local interconnection gateway. The registration procedure initiates locating functionalities, these functionalities being managed by the said interconnection gateway located in the visited country. If a multi-identifier SIM is used, on arrival in a country the mobile telecommunication device initiates the same registration procedure with the local interconnection gateway and initiates the same locating functionalities.

In this manner, the implementing of the invention has the following advantages:
If a local SIM is used, any call made by the subscriber is then a local call between his mobile telecommunication device and an interconnection gateway in the visited country, the call then being conveyed to a termination gateway on a mobile network of the country of the called person. If a multi-identifier SIM is used, and if the identifier is the identifier of a network of the visited country, any call is also a local call; if the identifier is a neighbouring country of the visited country, the call will not be a local call but a regional or continental call benefiting from a price rate close to the local rate.
Irrespective of the SIM used, any call received by the subscriber is managed by an interconnection router, this router determining the most suitable call termination procedure in relation to the cost of call termination on the mobile network of the visited country.

Advantageously, the present invention is designed so as to enable the operator of an interconnection network to control the costs of call gathering, interconnection and termination between a first national mobile cellular network (outgoing call) and a second national mobile cellular network (incoming call) both connected to the interconnection network.

The present invention also enables a user of a national cellular network to reduce communication costs for any call made towards or received from a mobile telephone on a cellular network abroad, when roaming.

Advantageously, the present invention has the specificity of ensuring operation across several cell telephone technologies such as GSM (Global System for Mobile Communication) or CDMA (Code Division Multiple Access).

The present invention also has the advantage of using existing protocols, methods and functionalities without having recourse to changes to the infrastructures of national cellular networks already set up.

Embodiments of the invention are described below as non-limiting examples, with reference to the appended drawings in which:

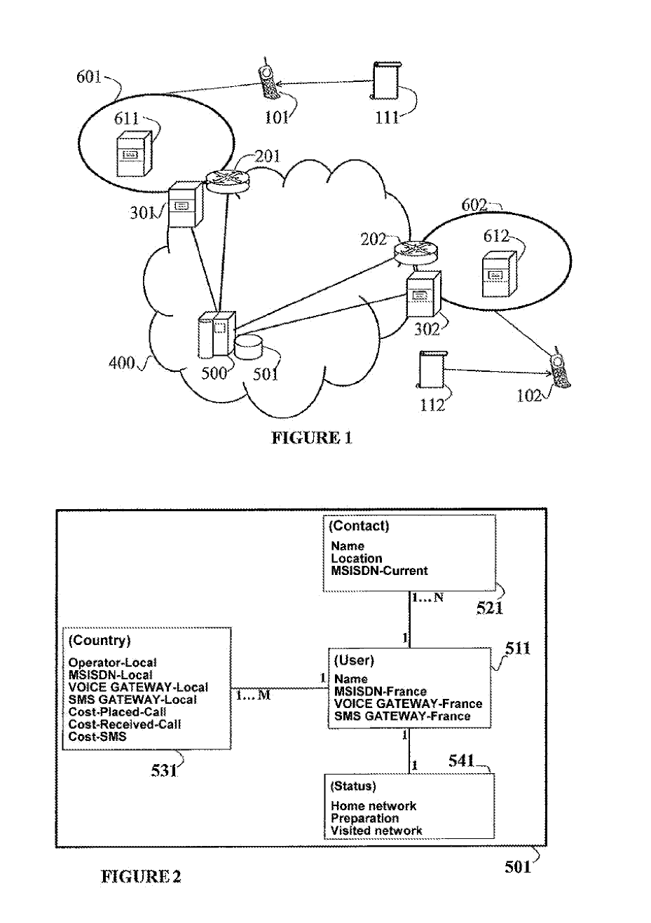

FIG. 1 is a schematic illustration of the architecture of a specific network, allowing the implementation of the method according to the invention.

FIG. 2 is a schematic illustration showing the main constituent elements of the database of the device allowing the implementation of the method of the invention.

FIG. 3 is a schematic illustration of a multi-identifier SIM card included in the device allowing the implementation of the method of the invention.

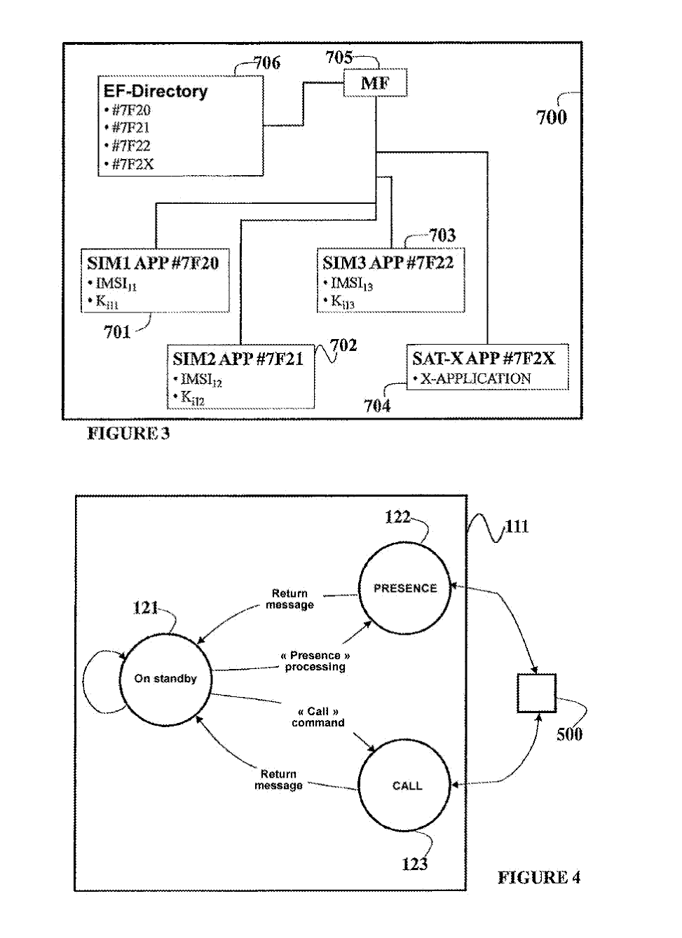

FIG. 4 is a schematic illustration of functioning of the application module.

FIG. 5 is a schematic illustration of the steps of a method linking the procedures for start-up of mobile communication means with a procedure for the setting up the [symbol] Presence [symbol] status according to the invention.

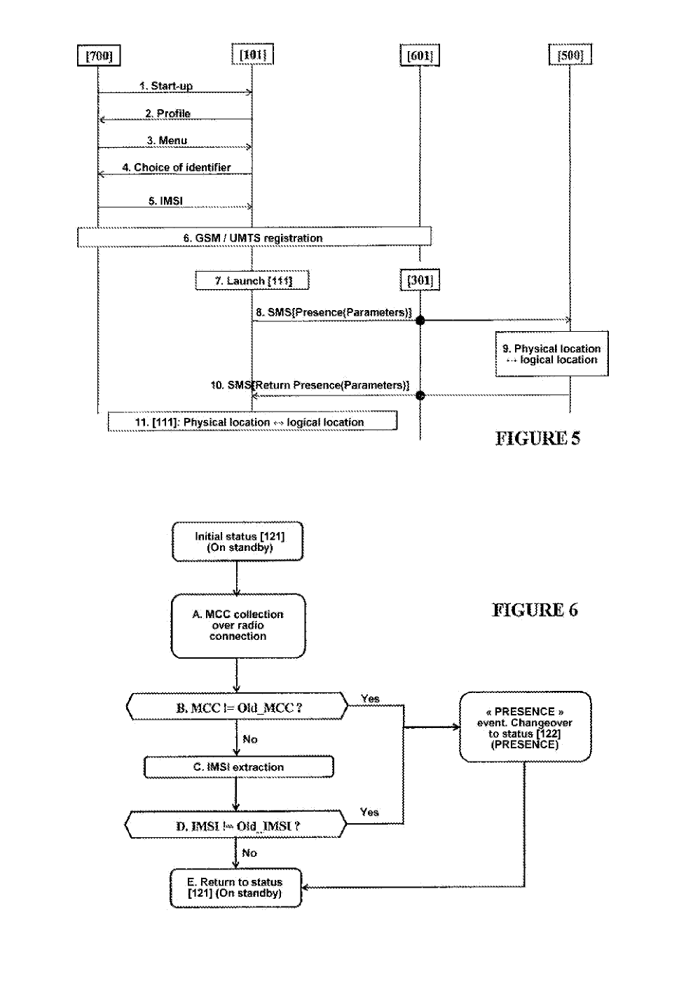

FIG. 6 is a schematic illustration in the form of a flow chart of an example of the processing of the [symbol] Presence [symbol] event according to the invention.

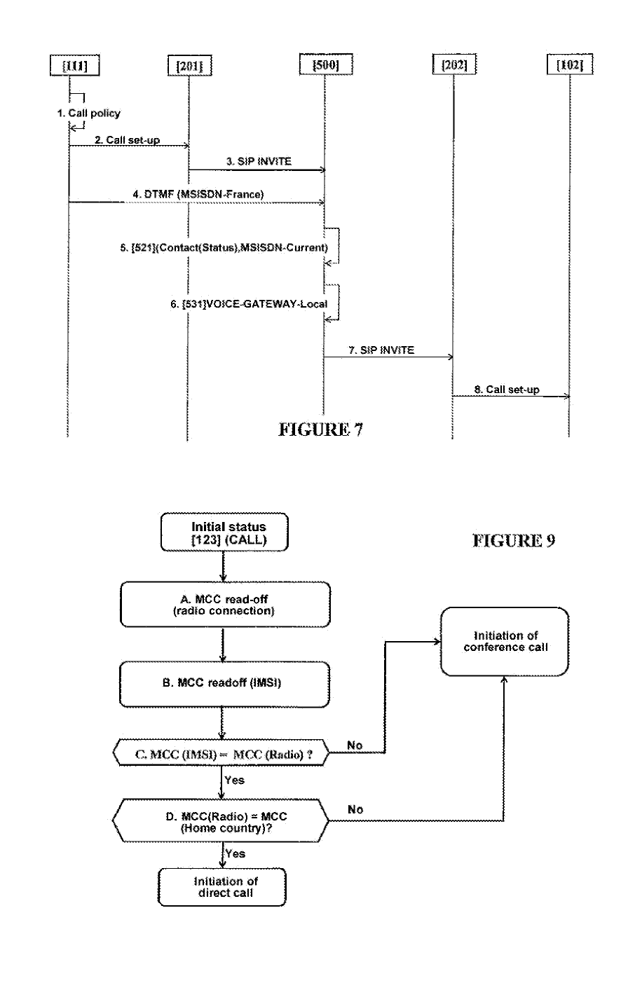

FIG. 7 is a schematic illustration of a sequence of steps which explain the functioning of call procedure with “direct” call termination.

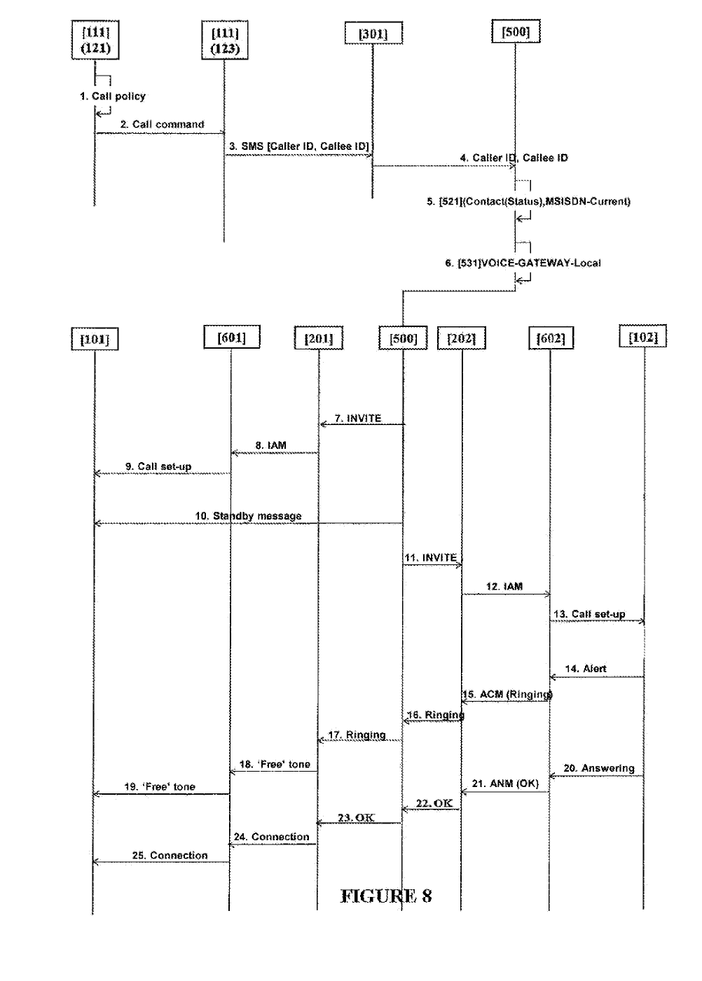

FIG. 8 is a schematic illustration of a sequence of steps which explain the functioning of said call procedure with “Call Back SMS” termination.

FIG. 9 is a schematic illustration in the form of a flow chart of an example of call management policies.

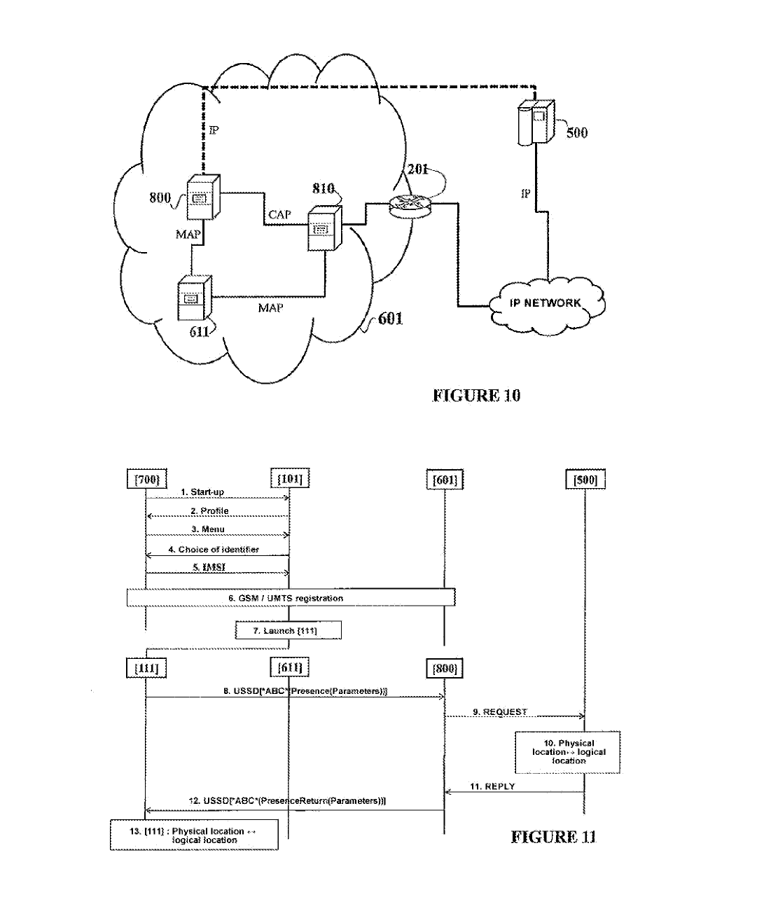

FIG. 10 is a schematic illustration of the underlying architecture of a cellular system compatible with CAMEL, evidencing the possibility of incorporating the system of the invention therein.

FIG. 11 schematically illustrates the adapting to the CAMEL platform of the steps of a method for linking between the start-up procedures of a mobile communication means and a procedure for setting up the [symbol] Presence [symbol] status according to the invention.

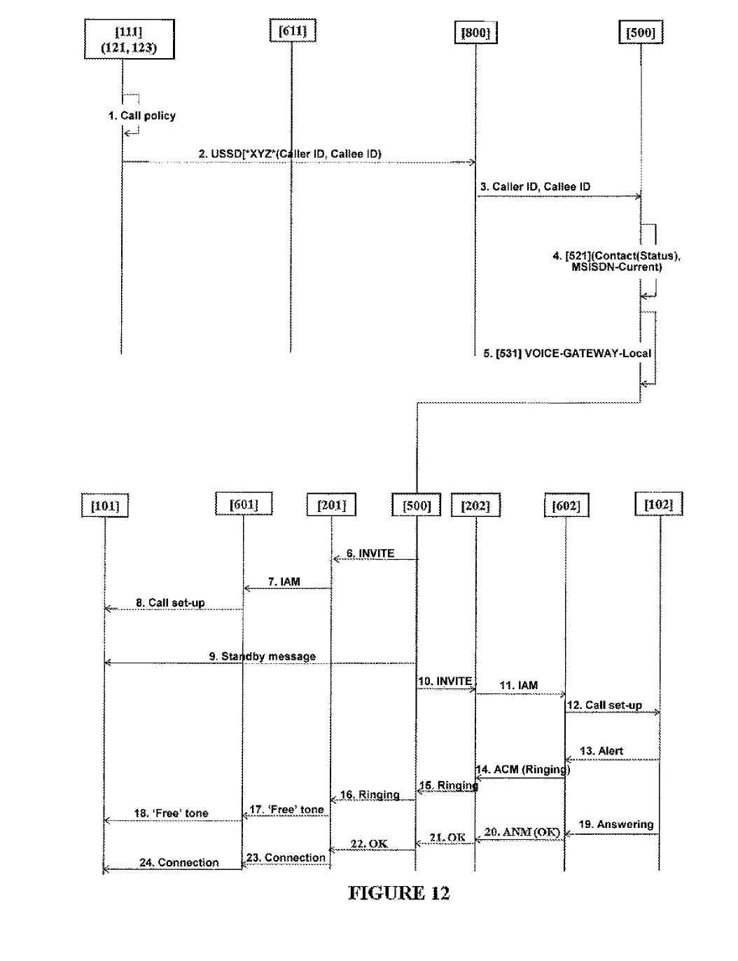

FIG. 12 schematically illustrates the procedure for adapting the “call-back SMS” procedure to the CAMEL platform, using “call-back USSD” procedure.

### FUNCTIONING OF THE GLOBAL ROAMING SYSTEM

In the following description the GSM/GPRS system (Global System for Mobile/General Packet Radio Service) will be considered to be the reference cellular network, and the signalling on the IP network (Internet Protocol) will conform to Session Initiation Protocol (SIP) standards. Evidently, this scenario is a possible example of embodiment: the principles of the invention can be extended to other cell systems (such as CDMA or UMTS (Universal Mobile Telecommunications System) and to other types of signalling on IP networks.

In this example, such as illustrated in FIG. 1, the device allowing the implementation of the method of the invention comprises a cellular telephony network 601 which is linked to a mobile telecommunication device 101 formed here by a mobile telephone.

Any communication for example by voice, short message (SMS), multimedia message (MMS) between the telephone 101 and the network 601 conforms to the standard defined by the “3^{rd} Generation Partnership Project” (3GPP) agency. The telephone 101 and the network 601 support all the functionalities and protocols required by 3GPP.

The device allowing the implementation of the method according to the invention, such as illustrated in FIG. 1, also comprises a cellular telephony network 602 with which a mobile telecommunication device 102 is linked such as a mobile telephone; the telephone 102 and the network 602 support all the functionalities and protocols required by 3GPP. The networks 601 and 602 are independent.

On the network 601, the data relating to the user of the telephone 101 is saved in a memory zone called “Home Location Register” (HLR-611). Similarly, for the user of the telephone 102, user-related data is saved in HLR 612.

When the user of the telephone is on his home network 601, he is systematically located on the network and is able to place a call after verification of his identity and validation of his rights by HLR 611, and in the same manner when he receives a call.

When travelling abroad, on network 602 for example, the user is able to continue using his telephone 101 with his home SIM and to register as visitor on the network 602, his own-related data being temporarily recorded in the network 602 to enable the operator of the network 602 to send data on the user's outgoing and incoming calls to his home operator 601 for invoicing of roaming calls.

When visiting a country the user of the telephone 101 can also use a local SIM of the network 602, replacing the home SIM in his telephone 101, or he can use telephone 102. When a local SIM of network 602 is used, the user's own-related data on network 601 is not known to HLR 612, and he cannot therefore be contacted via his home mobile number with network 601.

The device allowing the implementation of the method according to the invention, such as illustrated in FIG. 1, also comprises an application module 111 and 112 which is hosted in the mobile telecommunication devices 101 and 102 respectively, these application modules 111 and 112 being integrated in storage means of these mobile telecommunication devices 101, 102.

The device allowing the implementation of the method of the invention, such as illustrated in FIG. 1, also comprises “voice gateway” devices 201, 202 which guarantee logical and physical connection between each of the networks 601 and 602 respectively, and an “interconnection router” device 500 via the (public) Internet network. In this manner, the devices 201 and 202 ensure functionalities of “Softswitch” type known in the prior art: namely translation of signalling between SIP format and the telephone format “ISDN User Part” (ISUP), and the translation of the voice transport protocols between the circuit switched cellular networks and the packet switched Internet networks.

The device allowing implementation of the method of the invention, such as illustrated in FIG. 1, also comprises “SMS gateway” devices 301, 302 which guarantee logical and physical connection between—respectively—each of the networks 601 and 602 and the “interconnection router” device 500 via the (public) Internet network 400. In this manner, the devices 301 and 302 ensure translation of signalling between the “Short Message Relay Protocol” (SM-RP) format and the “Hypertext Transfer Protocol” (http) format between the circuit-switched cellular networks and the packet-switched Internet network.

The interconnection router device 500 guarantees logical and physical connection between several voice gateways such as the gateways 201 and 202, to ensure the conveying of signalling data and voice data between two mobile networks, such as networks 601 and 602, using the Internet network 400. The same interconnection router device 500 guarantees logical and physical connection between several SMS gateways such as the gateways 301 and 302 to ensure the conveying of SMS data between two mobile networks such as networks 601 and 602 using the Internet network 400. According to the explanations given below, the interconnection router 500 (and its associated database 501) is able to manage communications between the users of telephones 101 and 102 in relation to their location and to collection, interconnection and call termination costs between the networks 601 and 602.

Any skilled person will appreciate that the assembly of several voice gateways, of several SMS gateways, of an interconnection router (and its database) and of several application modules, forms a “super-network” of equipment/interconnection functionalities. This network being superimposed and operating in parallel with mobile networks and with interconnection networks between existing mobile networks. It will be shown in the remainder of the description that said “super-network” guarantees optimal interconnection (in terms of quality/price ratio) between existing mobile networks.

To allow better understanding of the operational procedures of the global roaming system, reference is made to an exemplary context of use in which:
Two French subscribers to the global roaming service travel to two different countries (England and the United States).
The first subscriber uses the mobile telephone 101, this telephone 101 comprises a local, continental or multi-identifier SIM card provided by the operator of the global roaming service, this SIM card (and its identifiers) being registered with the HLR 611 of the mobile network 601;
The second subscriber uses the mobile telephone 102, this telephone 102 is provided with a local, continental or multi-identifier SIM card provided by the operator of the global roaming service, this SIM card (and its identifiers) being registered with the HLR 612 of the mobile network 602.

In addition, such as illustrated in FIG. 2, the database 501 which is controlled by the provider of the global roaming service comprises the following main elements:
The user element 511 which comprises all the identifiers of a French subscriber to the global roaming service: name, “Mobile Station International ISDN Number” (MSISDN) telephone identifier allocated by his home cell operator, the “Voice-Gateway-France” telephone identifier of the device which interconnects with the French mobile network for any voice communication, the “SMS-Gateway” telephone identifier of the device which interconnects with the same French mobile network for any SMS communication.
The contact element 521 which comprises all the identifiers of each of N contacts forming part of the user's address book 511: name, current geographic location (home country or visited country), MSISDN-Current telephone identifier allocated by the home cell operator of the contact.
The country element 531 which comprises all the operator/network parameters for each country visited in which a French subscriber to the global roaming service may travel to; the identifier of the local operator, the MSISN-Local telephone identifier of the SIM card which the subscriber uses in this country, the “Voice-Gateway-Local” telephone identifier of the device 201 or 202 which interconnects with the mobile network 601 or 602 for any voice communication, the “SMS-Gateway” telephone identifier of the device 301 or 302 which interconnects with the foreign mobile network 601 or 602 for any SMS communication, the cost of a local call sent/received from the “Voice-Gateway-Local” device, the cost of an SMS sent to the “SMS-Gateway” device.
The status element 541 which functions as a finite state machine allowing the operational status of the user to be known at a given time.

According to one embodiment of the invention, such as illustrated in FIG. 3, a multi-identifier SIM card (also called multi-IMSI SIM) 700 comprises a file system defining a specific architecture.

For example a so-called “UMTS Integrated Circuit Card” (UICC) 700 comprises several GSM (“Global System for Mobile Communications”) and/or UMTS (“Universal Mobile Telecommunications System”) applications. Each GSM/UMTS application comprises a set of specific data such as identifiers, ciphering and authentication keys, administrative files, which enable the mobile communication means 101 hosting the UICC card 700 to dialogue with the cell network 601 comprising a set of corresponding data.

Such as illustrated in FIG. 3, this set of specific data comprises:
A GSM 11 application (SIMI APP#7F20) whose header #7F20 follows the format defined by the [symbol] 3^{rd} Generation Partnership Project [symbol] (3GPP). The application 701 notably comprises the subscriber international number (number IMSI₁₁) and the secret authentication key Kᵢ₁₁. The pair (IMSI₁₁, Kᵢ₁₁) allows communication between each mobile communication means 101 and the corresponding GSM cell network 601.
A UMTS application 702 (SIM2 APP #7F21). The application 702 in particular comprises the subscriber international number (IMSI₁₂number) and the secret authentication key Kᵢ₁₂. The pair (IMSI₁₂, Kᵢ₁₂) allows communication between each mobile communication means 101 and the corresponding UMTS cell network 601.
Another UMTS application 703 (SIM3 APP #7F22).
An application of [symbol] SIM Application Toolkit [symbol] type (SAT-X APP #7F2X) 704 which enables the multi-IMSI SIM card 700 to perform a [symbol] proactive [symbol] role: the multi-IMSI SIM card 700 is able to send commands to the mobile communication means 101, independently of the cell networks 601.
A directory called a [symbol] Master File [symbol] (MF) 705, acting as logical root for applications 701, 702, 703.
A directory 706 called [symbol] Elementary File [symbol] which comprises the pointers to applications 701, 702, 703 which the mobile communication means 101 is able to access.

The exemplary description in FIG. 3 implicitly refers to the model described in the specifications [symbol] Java Card 2.1 Runtime Environment [symbol] (JCRE). Depending on the functionalities and protocols of this model, each application (GSM/UMTS or other) is an [symbol] Applet [symbol] (an application which requires a virtual Java machine). The JCRE model is capable of choosing each Applet and allowing dialogue between the mobile communication means 101 and any Applet (in particular the GSM/UMTS applications) via specific protocols called APDUs ( [symbol] Application Protocol Data Unit [symbol] ).

FIG. 4 illustrates the operational functioning of the application module 111 which acts as a controller which changes status in accordance with commands entered by the user into his mobile communication means 101 or in accordance with automatic locating means, as is explained below. Therefore, the functioning of the application module 111 such as illustrated in FIG. 4 comprises the following steps:
Placing the application module 111 in [symbol] standby [symbol] status 121;
Processing by the application module 11 of an event of [symbol] Presence [symbol] type, which causes the controller to change over to [symbol] PRESENCE [symbol] status 122; in this status the application module 111 declares the geographic location of the user to the interconnection router 500. This declaration is made via a transported signalling protocol using:
   the physical and logical interface between the mobile communication means 101 (102) and the cell network 601 (602). This physical/logical interface may be of [symbol] short message [symbol] type (e.g. SMS) or of USSD type ( [symbol] Unstructured Supplementary Service Data [symbol] ) or of data type such as HTTP ( [symbol] HyperText Transfer Protocol [symbol] ).
   the physical and logical interface between the cell network 601 (602) and the interconnection router 500. This physical/logical interface is generally of data type such as HTTP ( [symbol] HyperText Transfer Protocol [symbol] ) or SIP ( [symbol] Session Initiation Protocol [symbol] ).

The [symbol] Presence [symbol] event advantageously allows the database 501 of the interconnection router 500 to know the geographic location of the user; this geographic location is stored in element 531 of the database 501. In addition, via the [symbol] Presence [symbol] event, it is also possible transmit to the database 501 of the interconnection router 500 the telephone identifier corresponding to the GSM application 701 or UMTS application 702 (or 703); this “logical” location is stored in elements 511 and 541 of the database 501. The database 501 of the interconnection router 500 is therefore able to match the logical location of the mobile communication means 101 (this location being characterized by the telephone identifier corresponding to one of the IMSIs of the multi-identifier SIM card 700 installed in the mobile communication means 101) with the geographic location of the user (this locating following the processing of the [symbol] Presence [symbol] event).
After receipt of the [symbol] Presence [symbol] command, the interconnection router 500 sends a return message to the application module 111 so that this module is also able to match the logical location with the physical location.

In addition, the command [symbol] Call [symbol] enables the application module 111 and the interconnection router 500 to set up a communication with another mobile communication means 102; the manner in which this communication is set up depends upon the result of the procedure for setting up the [symbol] Presence [symbol] status, the objective being to enable users of mobile telephony services to make calls at the best possible price rate, whether international and/or roaming calls. In general the two users of the mobile communication means 101 and 102 can be placed in contact using the following steps:
setting up a first local link between the communication means 101 of the caller and a first gateway 201 included in the network 601 deployed in the country or territory which said caller is visiting;
setting up a second link, preferably using the Internet network, between this first gateway 201 and a second gateway 202 included in a communication network 602 deployed in the country or territory of the user being called;
setting up a third local link between this second gateway 202 and the communications means 102 of the user being called.

The remainder of the description describes examples of possible operational scenarios for illustrating the functioning of the global roaming system and associated services. Persons skilled in the art will appreciate that these procedures and associated protocols may change according to embodiment without however departing from the spirit of the invention.

### Presence Procedure

FIG. 5 illustrates an example of a method for linking the start-up procedures of the mobile communication means 101 with the [symbol] Presence [symbol] procedure. Therefore the linking procedure comprises the following numbered steps such as illustrated in FIG. 5:
Steps 1 and 2: on start-up, the multi-identifier SIM card 700 and the mobile communication means 101 verify the compatibility of these mobile means with the [symbol] SIM Application Toolkit [symbol] (SAT);
Step 3: the multi-identifier SIM card 700 sends a start-up menu with the list of available SIM applications;
Steps 4 and 5: the user chooses a SIM application (for example the [symbol] France [symbol] SIM or [symbol] Italy [symbol] SIM or other). The multi-identifier SIM card 700 sends to the mobile communication means 101 the IMSI identifier corresponding to the chosen SIM application; it is interesting to note that depending on the functioning mode of the SIM card, steps 4 and 5 could be automated or transparent to the user.
Step 6: the registering procedures with the cell network 601 (GSM or UMTS network) are exchanged between the multi-identifier SIM card 700, the mobile communication means 101 and the cell network 601, these procedures being known to persons skilled in the art.
Step 7: the user starts up the application module 111. According to one variant of embodiment of the invention, on some models of mobile communication means 101, the application module 111 can be started up automatically.
Step 8: the [symbol] Presence [symbol] procedure is carried out by the application module 111: the parameters describing the physical and logical location are sent to the interconnection router 500 via the “SMS-Gateway” 301. In particular, a signalling SMS is initiated by the application module 111 towards the “SMS-Gateway” 301, this SMS containing the parameters for logical and physical locating of the mobile communication means 101 and of the user respectively. In turn the “SMS-Gateway” 301 may relay the location data to the interconnection router 500.
Steps 9 and 10: the interconnection router 500 records the location data and sends back a return message to the “SMS-Gate-way” 301; in turn, the “SMS-Gateway” 301 can relay the location data to the application module 111 via an SMS.
Step 11: the same location data is recorded by the application module 111 of the mobile communication means 101;

FIG. 6 illustrates an example of processing policies of the [symbol] Presence [symbol] event according to one possible variant of implementation. Those skilled in the art will appreciate that other policies may be set up without however violating the spirit of the invention. According to the diagram illustrated in FIG. 6, these management policies of the [symbol] Presence [symbol] event are performed by the application software 111 (which initially is in status 121 [symbol] Standby [symbol] ) as per the following steps:
Step A. The application module 111 initiates recognition of the “Mobile Country Code” (MCC). The MCC is a three-figure code standardized by the International Telecommunications Union (ITU) in its recommendation E.212 to identify the countries in mobile telephony networks, more particularly in the GSM and UMTS technologies. It is possible to recognize the MCC from the radio link between the mobile communication means 101 and the cell network 601 to which it is attached.
Step B. The value of the MCC is compared with the value stored in a memory region controlled by the application software 111. If the two values differ, this means that the subscriber to the global roaming service has changed country: the [symbol] Presence [symbol] event is then initiated and the controller of the application module 111 changes over to the [symbol] PRESENCE [symbol] status 122 to declare the new geographic location of the user to the interconnection router 500.
Step C. If the two values of MCC are identical, the “International Mobile Subscriber Identifier” is then analysed from the SIM card inserted in the communication means 101.
Step D. The IMSI value is compared with the value stored in a memory region controlled by the application software 111. If the two values differ this means that the subscriber to the global roaming service has changed GSM (UMTS) network: the [symbol] Presence [symbol] event is then initiated and the controller of the application module 11 changes to [symbol] PRESENCE [symbol] status 122 in order to declare the new logical location of the mobile communication means 101 to the interconnection router 500.

### Call Procedure—“Direct” Call Termination

Example of context: a French user of the global roaming service calls a second user (French) of the global roaming service visiting the United States. The outgoing call procedure is managed by an application module 111 of the mobile telephone 101. The incoming call procedure towards the mobile telephone 102 is managed by the interconnection router device 500. FIG. 7 illustrates a sequence of numbered steps which explain the functioning of said call procedure with “direct” call termination:
Step 1. Further to a call initiation command by the caller user, the controller of the application module 111 changes to “Call” status 123 to verify the call management policies to be applied. These policies will be explained in more detail below.
Step 2. Still in the “Call” status 123, the application module 111 initiates call set-up procedure towards the “Voice-Gateway-Local” device 201 (France). The call signalling between the switching centres of the local cell network 601 and the “Voice-Gateway-Local” device 201 conforms to standard “ISDN User Part” (ISUP) well known to those skilled in the art. The call set-up procedure initiated by the application module 111 conforms to the standard “URLs for Telephone Calls” defined in document “RFC2806” by the “Internet Engineering Task Force”. According to this standard, suitable syntax for the call initiation procedure allows the sending of so-called “Dual-Tone Multi Frequencies” (DTMF) as soon as a communication channel is set up between two entities of a telephone network. The document “RFC2806” is well known to those skilled in the art. On completion of step 2, the controller of the application module 111 returns to the “standby” status 121.
Step 3. After set-up of the call (Step 2) the “Voice-Gateway-Local” 201 initiates call set-up procedure towards the interconnection router 500. Said procedure conforms to the standard “Session Initiation Protocol” (SIP). For example, the header of the SIP procedure contains a “From” field of type: MSISDN-Current@ Voice-Gateway-Local. It is therefore possible for the interconnection router device 500 to know the telephone identifier of the caller and the corresponding “Voice-Gateway-Local”.
Step 4. On completion of steps 2 and 3, a “voice” communication channel is set up between the mobile telephone 101 and the interconnection router 500 via the “Voice-Gateway-Local” 201. By means of the call initiation procedure performed by the application module 111, as soon as said communication channel is set up, the DTMF (Dual Tone Multifrequency) corresponding to the telephone identifier “MSISDN-France” of the called person are sent from the mobile telephone 101 to the interconnection router device 500 via the “Voice-Gateway-Local” 201.
Step 5. The interconnection router device 500 polls the Contact part 521 of the database 501 to obtain the current location (United States) of the “MSISDN-Current” telephone identifier of the called person.
Step 6. The interconnection router device 500 polls the Country part 531 of the database 501 to obtain the telephone identifier of the “Voice-Gateway-Local” device 202 (United States).
Step 7. The interconnection router device 500 initiates call set-up procedure towards the “Voice-Gateway-Local” device 202. Said procedure conforms to the standard “Session Initiation Protocol” (SIP). For example, the header of the SIP procedure contains a “To” field of type: MSISDN-Current@Voice-Gateway-Local, the identifier MSISDN-Current referring to the called person. It is therefore possible for the “Voice-Gateway-Local” device 202 to know the telephone identifier to be called.
Step 8. After step 7, the “Voice-Gateway-Local” device 202 initiates call set-up procedure towards a mobile telephone 102 (in the United States). The call signalling between the switching centres of the local cell network 602 and the “Voice-Gateway-Local” device 202 conforms to the standard “ISDN User Part” (ISUP) well known to persons skilled in the art.

On completion of steps 2 and 3, a “voice” communication channel is set up between the mobile telephone 101 ad the interconnection router 500, via the “Voice-Gateway-Local” 201. Similarly, on completion of steps 7 and 8, a “voice” communication channel is set up between the mobile telephone 102 and the interconnection router 500 via the “Voice-Gateway-Local” 202. It is therefore possible for the interconnection router device 500 to set up a bridge between the different communication sections in order to place in contact the mobile telephone 101 of the caller (in France) with the telephone 102 of the called person (in the United States).

### Call Procedure—Conference Calling

Example of context: a French user of the global roaming service travelling in England calls another (French) user of the global roaming service travelling in the United States. The outgoing call procedure is managed by the application module 111 of the mobile telephone 101. The interconnection router device 500 receives the call request by SMS and initiates a call towards mobile telephone 101, a second call towards mobile telephone 102, and places them in a conference call. FIG. 8 illustrates a sequence of numbered steps which explain the functioning of such call procedure—conference calling.
Steps 1, 2: After receiving a call initiation command from the caller user, the automation of the application module 111 changes over to “Call” status 123 to verify the call management policies to be applied. These policies are explained below in more detail.
Step 3. The controller of the application module emits a control instruction in SMS comprising the number of the called person with his international area code towards the “SMS-Gateway” device 301.
Step 4. The “SMS-Gateway” 301 initiates call set-up procedure towards the interconnection router device 500. According to one example of implementation, said procedure conforms to the standard ‘HyperText Transfer Protocol” (HTTP). The header of the procedure, http GET (or http POST), contains the MSISDN-Current of the caller and the MSISDN of the called person.
Step 5. The interconnection router device 500 polls the Contact part 521 of the database 501 to obtain the current location (United States) and “MSISDN-Current” telephone identifier of the person being called.
Step 6. The interconnection router device 500 polls the Country part 531 of the database 501 to obtain the telephone identifier of the “Voice-Gateway-Local” device 202 (United States).
Step 7. The interconnection router device 500 opens a conference calling session. It initiates call-back procedure towards the “Voice-Gateway-Local” device 201. Said procedure conforms to the Session Initiation Protocol standard (SIP). For example, the header of the SIP procedure contains a “To” field of type: MSISDN-Current@Voice-Gateway-Local, the MSISDN-Current identifier referring to the caller. It is then for the “Voice-Gateway-Local” device 201 to know the telephone identifier to be called.
Step 8. The “Voice-Gateway-Local” device 201 uses the received MSISDN number to locate the GMSC (Gateway Mobile Switching Centre) of the mobile network of the caller 101. Once the GSMC is identified, an “IAM” signal (Initial Address Message) is relayed to the latter.
Step 9. The MSC/VLR (“Mobile Switching Centre/Visiting Location Register”) of the cell network 601 which currently controls the cell telephone 101 of the caller verifies that the called number is indeed contained in its routing tables and proceeds with calling back the caller 101. Persons skilled in the art will appreciate that step 9 consists of several sub-steps, in particular if the (French) caller is roaming in England. In this exemplary case, the MSC/VLR belongs to a local English “visited” cell network, whilst the GMSC at step 8 belongs to the caller's original network. All the sub-steps describing the interactions between the “visited” network and the original network are not described since they are well known to skilled persons.
Step 10. After step 9, a communication channel is set up between the interconnection router device 500 and the mobile telephone 101. A waiting message can be sent to the caller.
Steps 11, 12, 13. Identical to corresponding steps 7, 8, 9: after step 13, a communication channel is set up between the interconnection router device 500 and the mobile telephone 102.
Step 15. The GSMC of cell network 602 sends the “Voice-Gateway-Local” device 202 (United States) an “ACM” message (Address Complete Message) to inform the device 202 that a circuit has been reserved.
Steps 16 to 19. After step 15, the “Voice-Gateway-Local” device 202 sends back to the interconnection router 500 a SIP message of “Ringing” type. This message is relayed by all the network elements concerned so that the caller is able to hear the “free” tone coming from the called person's mobile telephone 102.
Step 21. After the mobile telephone 102 has answered, the GSMC of the cell network 602 sends back to the “Voice-Gateway-Local” device 202 (United States) an “ANM” message (ANswer Message) to inform the device 202 that the called person has answered.
Steps 22 to 25. After step 21, the “Voice-Gateway-Local” device 202 sends back to the interconnection router 500 a SIP message of “OK” type. This message is relayed by all the network elements concerned so that a direct connection is able to be set up between the caller and the callee.

The call procedures such as illustrated in FIGS. 7 and 8 allow a reduction in the cost of a call towards the mobile network 602 (United States). The called person does not pay anything if he is on his home network; on the other hand, he must pay a received call cost if he is roaming abroad. The caller pays in accordance with the direct call policies if he is on his home network; on the other hand, he must pay a received call cost (network call-back) if he is roaming abroad.

### Call Management Policies

The described system must enable users of mobile telephony services to place and receive calls, international calls and/or roaming calls, at the best possible price rate. At the same time, the system must enable the provider of the global roaming service to reduce interconnection and call termination costs. In this respect, call management policies must be set up, these policies being under the control of the application module 111. FIG. 9 illustrates an example of call management policies according to one possible variant of implementation. Those skilled in the art will appreciate that other policies may be set up without, however, violating the spirit of the invention. According to the diagram in FIG. 9, these call management policies may translate as the implementation of the following steps:
Initial Status. Further to a call initiation command entered by the user, the application module 111 changes over to the “CALL” status 123.
Step A. The application module reads the current value of the MCC stored in a specific memory region. This value had been previously obtained from a radio link between the mobile communication means 101 and the cell network 601 to which it is attached. In the remainder hereof this value will be called ‘MCC_Radio”.
Step B. The application module reads a second current value of the MCC stored in a specific memory region. This value had been previously obtained from one of the IMSIs of the Multi-IMSI SIM card inserted in the mobile communication means 101. In the remainder hereof this value will be called “MCC_IMSI”.
Step C. The” “MCC_Radio” and “MCC_IMSI” values are compared. If they are different, the physical location of the user and the “logical” location (in the meaning of the GSM/UMTS network) are different. In this case, call procedure of “conference calling” type (FIG. 8) is initiated. On the other hand, if the “MCC_Radio” and “MCC_IMSI” values are identical, Step D is carried out.
Step D. The application module 111 verifies whether the “MCC_Radio” value corresponds to the user's home country. It is important to note that for a Multi-IMSI SIM, the user has several “Home countries”; in this case, several physical locations of the user may correspond to as many “logical locations” of the mobile communication means 101. If the “MCC_Radio” value corresponds to one of the home countries of the user, call procedure of “direct call” type (FIG. 7) is initiated; if not, call procedure of “conference calling” type (FIG. 8) is initiated.

It is to be noted that the described call management policies also apply if the person receiving the call request corresponds to a landline number.

It is also to be noted that the same policies may apply if the called person is not a subscriber to the global roaming service and therefore his mobile telephone does not host the application module 112: in this case, the called person will be considered as being in his home country.

### Variant of Embodiment

At the current time in the world, several strategies for developing wireless cell networks are being researched and/or are starting to be deployed. Among these solutions, particular efforts by cell operators are being dedicated to the setting up of the “IP Multimedia Subsystem” (IMS), which allows the providing of landline and mobile multimedia services to subscribers. One intermediate step towards this type of development is formed by the service support platform called “CAMEL” (Customized Applications Mobile network Enhanced Logic”).

CAMEL forms the reference service architecture for mobile phone operators. The standardization work initiated by ETSI (European Telecommunication Standard Institute), then continued by 3GPP, consisted of adapting to the mobile phone context the notion of an intelligent network developed by the ITU (International Telecommunications Union). A multitude of services can be supported by a CAMEL platform. For example, with the support of a service such as “prepaid card”, CAMEL has made a noteworthy contribution to the success of GSM. The deployment of CAMEL by the majority of mobile operators is evidence of its stability and maturity.

The procedures described when presenting the invention lend themselves to CAMEL-compatible development and deployment; within this context, the architecture, protocols and procedures must be adapted so that they can use the methods, primitives and interconnections described in the CAMEL standard. Nonetheless, the basic principles of the invention remain the same.

FIG. 10 illustrates the underlying architecture of a cell system which supports CAMEL and also one possible way of “grafting” the system of the invention thereupon. To simplify the description, the architecture essentially refers to “Phase 1” of CAMEL. Any skilled person will be able to ascertain hereafter that the principles of the description can also be applied to CAMEL “Phase 2”. It is also to be noted that a sub-assembly of functional blocks of the cell network 601 is illustrated in FIG. 10. The chief functionalities of CAMEL are well known to skilled persons. Nonetheless, it is useful to recall some details with reference to the illustration in FIG. 10:
gsmSCF 800 (SCF stands for “Service Control Function”) is the entity containing the CAMEL services. gsmSCF 800 is controlled by the home cell operator. The node in which gsmSCF is contained is called the “Service Control Point” (SCP 800). SCP 800 supports the following protocols:
   MAP (“Mobile Application Part”) standardized by the 3GPP agency, represented by a solid line in FIG. 10, which allows interfacing between SCP 800 and HLR 611;
   CAP (‘CAMEL Application Part’) standardized by the 3GPP agency, represented by a solid line in FIG. 10, and which allows interfacing between SCP 800 and gsmSSF 810.
   One or more IP-based protocols to communicate with the interconnection router 500 in the country of the home cell operator. This type of protocol is not standardized. It is therefore to be based on owner implementation.

It is interesting to note that the interconnection router 500 can be controlled by the provider of the global roaming service, whilst the home cell operator controls SPC 800. Access and interfacing agreements must be drawn up between the two economic players.
gsmSSF 810 (SSF stands for “Service Switching Function)” is a functional entity contained in the “Gateway Mobile Switching Function” GMSC (in the network of the home cell operator) and in the “Visiting Location Register”/“Mobile Switching Function” (VLR/MSC) (in the network of the home or visited cell operator). gsmSSF 810 supports the following protocols:
   MAP (“Mobile Application Part”) standardized by the 3GPP agency, represented by a solid line in FIG. 10 and which allows interfacing with HLR 611.
   CAP (“CAMEL Application Part”) standardized by the 3GPP agency, represented by a solid line in FIG. 10 and which allows interfacing with SCP 800.
The interconnection router 500 is functionally linked by IP-based protocols (represented by a solid line in FIG. 10).
The voice gateway 201 is functionally linked by “ISDN User Part” protocols (ISUP) with GSMC (or VLR/MSC) which hosts the gsmSSF 810 functionality.

It is interesting to note that for a Multi-IMSI SIM, several instances of the cell network 601 are present. Therefore several instances of the devices 800 and 810 will be available. It will then be possible functionally to link together:
The interconnection router 500 with several SCP 800 functions, via IP-based protocols (represented by a chain dotted line in FIG. 10).
The voice gateway 201 with several GMSCs (or VLR/MSC) which host the gsmSSF 810 functionality via “ISDN User Part” (ISUP) protocols.

In the remainder of the description, the adaptation of the procedures of the invention to the CAMEL platform will be explained.

### Presence Procedure

Functionally, there are no major changes compared with the procedures illustrated in FIG. 5. Any signalling SMS between an application module 111 and the support network is replaced by messages of type “Unstructured Supplementary Service Data” (USSD). In addition, it is necessary for HLR 611 to have knowledge that its subscribers may be users of the global roaming service. In this respect, it is necessary to define an identifier of the “Presence” services in the database of HLR 611: in particular, the so-called “UG-CSI” element (“US SD Generic CAMEL Subscription Information”) must contain the USSD service codes of “Presence” (code “*ABC*” in FIG. 11) and the logical address of the gsmSCF 800 which will process said USSD messages. The USSD protocol is well known to skilled persons. FIG. 11, as an example, illustrates the procedure for adapting the “Presence” procedure to the CAMEL platform, this adapting procedure comprising the following steps:
Steps 1 to 7. These are identical to the corresponding steps in FIG. 5.
Step 8. Further to a user command, the application module 111 makes a call using USSD syntax: *ABC*Body part in which *ABC* is the USSD service code defined in the CAMEL platform, this code corresponding to the “Presence” procedure and the Body part comprising the current telephone identifier of the Multi-IMSI SIM,card and the description of the physical location of the user. The request for the USSD service is relayed from the HLR 611 to the gsmSCF 800 included in the SCP 800.
Step 9. Via a http request, the SCP 800 device initiates a “Presence” request towards the interconnection router 500.
Step 10. The interconnection router 500 and its database 501 record the location data.
Step 11. Via a http request, the interconnection router 500 sends back a reply to the SCP 800 device.
Step 12. In turn, the SCP 800 device sends back a reply to the application module 111 using USSD syntax: *ABC* Body part, Body part comprising the telephone identifier of the local SIM card and the parameters needed by the application module 111 of the mobile communication means 101 to record the physical and logical location data (Step 13).

### Variant of Call Procedure—Conference Calling Via “USSD”

Functionally, there are no major changes compared with the steps described in FIG. 8. Any signalling SMS between the application module 111 and the “SMS-Gateway” device 302 is replaced by messages of type

“Unstructured Supplementary Service Data” (USSD), these messages being exchanged between the SCP 800 device and the application module 111 via the HLR 611. Similar to the “Presence” case, it is necessary to define an identifier of the “Call-back USSD” service in the database of the HLR 611; in particular the so-called “UG-CSI” element (“USSD Generic CAMEL Subscription Information”) must contain the code of such services (code ‘*XYZ* in FIG. 12) and the logical address of the gsmSCF 800 which will process such USSD messages. FIG. 12, as an example, illustrates the adapting of the “call-back SMS” procedure illustrated in FIG. 8 to the CAMEL platform, using “call-back USSD” procedure. It is to be noted that steps 6 to 24 in FIG. 12 correspond exactly to steps 7 to 25 in FIG. 8. Therefore, only steps 1 to 5 in FIG. 12 will be detailed:
Step 1. Further to a call initiation command entered by the caller user, the controller of the application module 111 changes over to [symbol] Call [symbol] status 123 to verify the call management policies to be applied.
Step 2. The application module 111 sends a call request using USSD syntax: *XYZ*Body part in which *XYZ* is the code of the USSD service defined in the CAMEL platform, this code corresponding to “call-back US SD” procedure and the Body part containing the number of the called person with his international area code.
Step 3. The SCP 800 device initiates call set-up procedure towards the interconnection router device 500. According to one example of implementation, said procedure conforms to the standard “HyperText Transfer Protocol” (HTTP). The header of the procedure http GET (or http POST) will contain the MSISDN-Current of the caller and the MSISDN of the person receiving the call.
Step 5. The interconnection router device 500 polls the Contact part 521 of the database 501 to obtain the current location (United States) and the “MSISDN-Current” telephone identifier of the called person.

Another variant of embodiment consists of replacing the short signalling messages (SMS or USSD) by connections of type HyperText Transfer Protocol (http). The body of the messages http GET (or http POST) contains the data needed for performing “Presence” procedures and the procedure for conference calling. The application module 111 initiates the sending of a request of type http GET (or http POST) towards the interconnection router 500. Functionally, the sequence of operations and the exchanges of associated messages are identical for the SMS or USSD cases.

### INDUSTRIAL APPLICATIONS AND FIELDS OF APPLICATION

Any cell and IP system and infrastructure is compatible with the above-described method, devices and operational steps.

The implementing of the invention especially comprises use of the equipment and software necessary for communication between the devices and sub-devices illustrated in the different Figures.

The principles of the invention can advantageously be applied by the following economic players:
Companies with subsidiaries in foreign countries: they may adopt the solution to obtain a roaming service of lower cost, to allow a significant reduction in communication expenses (telephone, SMS, data) for employees travelling between the different sites.
Providers of large capacity infrastructures (for example IIJ—“Internet Initiative Japan”, “NTT Communications”, “AIH—Asia Internet Holding”, “TI-Sparkle”) which may offer the solution subject of the invention as a new interconnection and traffic conveying service.
Cell operators who adopt incompatible technologies (for example, Orange with GSM/GPRS/UMTS and Korea Telecom with cdmaOne) may benefit from a simple solution to ensure compatibility of services provided, such as voice and SMS. In addition, a cell Operator who has no roaming agreements with the cell Operator of a foreign country, can adopt the described interconnection solution to set up roaming agreements without having to have recourse to the intermediary of third party operators. Such is the case of national operators.

1. A method for providing interconnection services,
characterized in that it links a set of national cell networks (601, 602) with an interconnection network via gateway servers (201, 202, 301, 302) which are controlled by a central routing server (500) in order to set up a global communication network between mobile telecommunication devices (101, 102) such as mobile telephones; an application module (111, 112) which allows dialogue between each mobile telecommunication device (101, 102) and the central routing server (500) is hosted on the mobile telecommunication device (101, 102) of each user, this application module (111, 112) acting as a controller which changes status in accordance in particular with instructions entered by the user on his mobile telecommunication device (101, 102) or further to a change of SIM card in the mobile telecommunication device (101, 102) or further to a change in country of the user; in addition, a logical and physical connection between several gateways (201, 202, 301, 302) is obtained by means of an interconnection routing device (500) which manages communication between the users of mobile telecommunication devices (101, 102) in relation to their location and to collecting, interconnecting and call termination costs between the networks (601, 602).

2. The method according to claim 1, allowing the interconnection between cell networks,
characterized in that it comprises the steps of:
registering the user with an interconnection router (500) and allocating identification data to a mobile telecommunication device (101, 102) of the user, this data being recorded in memory means included in the interconnection router (500) or to which the router has access;
installing in a user's mobile telecommunication device (101, 102):
a multi-identifier SIM card (700);
an application module (111, 112);
travel by the said user and his arrival in a new country or territory;
registering this user with a mobile network (601, 602) deployed in the country or territory in which the user is travelling, an identifier being allocated to the user's mobile telecommunication device (101, 102); by means of the multi-identifier SIM card (700) the user carries out such registration as subscriber to the said network (601, 602) and not as a foreign visitor;
sending, by the application module (111, 112) to the interconnection router (500), the identifier of the user's mobile communication device (101, 102) within said network (601, 602) with which the user has registered;
association of this identifier with the identification data of the user's mobile telecommunication device (101, 102);
chaining all the numbers of the said multi-identifier SIM card (700) onto the user's home number in the routing server (500).

3. A device for providing interconnection services allowing the implementation of the method according to claim 1,
characterized in that it comprises:
a cell telephony network (601) which is linked to a mobile telecommunication device (101) here consisting of a mobile telephone;
a cell telephony network (602) with which a mobile telecommunication device (102) is linked, this network (602) extending in a foreign country different from the one in which the said network (601) extends;
a memory zone called “Home Location Register” (HLR-(611, 612) included in each telephony network (601, 602) which particularly comprises characteristics allowing the locating, identification of the mobile telephone (101) and sales-related data;
an application module (111,112) which is hosted in mobile telecommunication devices (101, 102) respectively, these application modules (111, 112) being integrated in storage means of these mobile telecommunication devices (101, 102);
“voice gateway” devices (201, 202) which guarantee logical and physical connection between respectively each of the networks (601, 602) and an “interconnection router” device (500) via the (public) Internet network (400);
“SMS gateway” devices (301, 302) which guarantee logical and physical connection between—respectively—each of the networks (601, 602) and the “interconnection router” device (500) via the (public) Internet network (400);
an interconnection router device (500) which guarantees logical and physical connection between several voice gateways, such as the gateways (201, 202) to ensure the conveying of signalling data and voice data between two mobile networks, such as networks (601, 602) using the Internet network (400); this interconnection router device (500) also guarantees logical and physical connection between several SMS gateways, such as gateways (301, 302) to ensure the conveying of SMS data between two mobile networks, such as networks (601, 602) using the Internet network (400);
a database (501) associated with the interconnection router (500).

4. The device according to claim 3,
characterized in that the database (501) comprises the following main elements:
a user element (511) which comprises all the identifiers of a subscriber: name, the telephone identifier “Mobile Station International ISDN Number” (MSISDN), the telephone identifier “Voice-Gateway” of the device (201, 202) which interconnects with the local mobile network for all voice communications, the telephone identifier “SMS-Gateway” of the device (301, 302) which interconnects with the same local mobile network for all SMS communications;
the contact element (521) which comprises all the identifiers of each N element forming part of the user's address book (511): name, current location (home country or visited country), the telephone identifier MSISDN-Current (in the home country or in the visited country);
the country element (531) which comprises all the operator/network parameters for each visited country to which a user may travel: identifier of the local operator, MSISDN-Current telephone identifier among the possible identifiers of the multi-identifier SIM card (700) which the user uses in this country, the “Voice-Gateway” telephone identifier of the device (201 or 202) which interconnects with the foreign mobile network (601 or 602) for any voice communication, the “SMS-Gateway” telephone identifier of the device (301 or 302) which interconnects with the foreign mobile network (601 or 602) for all SMS communications, the cost of a local call sent to/received from the “Voice-Gateway” device, the cost of an SMS sent to the “SMS-Gateway” device;
the Status element (541) which functions as a finite state machine allowing the operational status of the user to be known at a given time.

5. The method for providing interconnection services according to claim 1,
characterized in that it comprises the so-called “Presence” procedure carried out by the user after a change of country, this “Presence” procedure whose objective is to verify the user's rights and match the physical location of the user with the logical location of the mobile telecommunication device (101, 102) and of the multi-identifier SIM card (700), translating as the implementation of the following steps:
Steps 1 and 2: on start-up, the multi-identifier SIM card (700) and the mobile telecommunication device (101, 102) verify the compatibility of this device with the [symbol] SIM Application Toolkit [symbol] (SAT);
Step 3: the multi-identifier SIM card (700) sends a start-up menu with the list of available SIM applications;
Steps 4 and 5: the user chooses a SIM application (for example SIM [symbol] France [symbol] or SIM [symbol] Italy [symbol] , or other); the multi-identifier SIM card (700) sends to the mobile communication means (101, 102) the IMSI identifier corresponding to the chosen SIM application; depending on the functioning mode of the SIM card, steps 4 and 5 may be automatic and transparent to the user;
Step 6: the registration procedures with the cell network (601) (GSM or UMTS network) are exchanged between the multi-identifier SIM card (700), the mobile communication means (101, 102) and the cell network (601, 602);
Step 7: the user starts the application module (111, 112);
Step 8: the “Presence” procedure is performed by the application module (111; 112): the parameters describing the physical and logical location are sent to the interconnection router (500) via the “SMS-Gateway” (301); in particular a signalling SMS is initiated by the application module (111, 112) towards the “SMS-Gateway” (301), this SMS containing the parameters of logical and physical locating of the mobile communication means (101, 102) and of the user respectively; in turn, the “SMS-Gateway” (301) can relay location data to the interconnection router (500);
Steps 9 and 10: the interconnection router (500) records the location data and send backs a message to the “SMS-Gateway” (301); in turn, the “SMS-Gateway” (301) can relay the location data to the application module (111, 112) via an SMS;
Step 11: the same location data is recorded by the application module (111, 112) of the mobile communication means (101, 102).

6. The method according to claim 5,
characterized in that the application module (111, 112) initiates the “Presence” procedure by performing the following steps:
Step A: the application module (111, 112) initiates recognition of the “Mobile Coutry Code” (MCC) from the radio link between the mobile communication means (101, 102) and the cell network (601, 602) to which it is attached;
Step B: the MCC value is compared with the value stored in a memory region controlled by the application software (111, 112); if the two values differ, the user has changed country: the “Presence” event is then initiated and the controller of the application module (111, 112) changes to “PRESENCE” status (122) to declare the new geographical location of the user to the interconnection router (500);
Step C: if the two MCC values are identical, the IMSI is then analyzed from the SIM card inserted in the communication means (101, 102);
Step D: the IMSI value is compared with the value stored in a memory region controlled by the application module (111, 112); if the two values differ, this means that the user has changed network GSM (UMTS): the “Presence” event is then initiated and the controller of the application module (111, 112) changes to “PRESENCE” status (122) to declare the new logical location of the mobile communication means (101, 102) to the interconnection router (500).

7. The method according to claim 1,
characterized in that a user initiates an outgoing call procedure from his home country; this procedure termed calling with “direct” call termination comprises the performing of the following steps:
Step 1: further to a call initiation command entered by the user, the application module (111) verifies the call management policies to be applied;
Step 2: the application module (111) initiates call set-up procedure towards the “Voice-Gateway” device (201); call signalling between the switching centres of the local cell network (601) and the “Voice-Gateway” device (201) conforms to the standard “ISDN User Part” (ISUP);
Step 3: after call set-up (Step 2) the “Voice-Gateway” device (201) initiates call set-up procedure towards the interconnection router device (500); said procedure conforms to the standard “Session Initiation Protocol” (SIP);
Step 4: on completion of steps 2 and 3, a “voice” communication channel is set up between the mobile communication means (101) and the interconnection router (500) via the “Voice-Gateway” device (201); by means of the call initiation procedure performed by the application module (111, 112), as soon as said communication channel is set up, the DTMF tones (“Dual Tone Multifrequency”) which correspondent to the telephone identifier “MSISDN-France” of the called person are sent by the mobile communication means (101) to the interconnection router device (500) via the “Voice-Gateway” (201);
Step 5: the interconnection router device (500) polls the Contact part (521) of the database (501) to obtain the current location and “MSISDN-Current” telephone identifier of the person being called;
Step 6: the interconnection router device (500) polls the Country part (531) of the database (501) to obtain the telephone identifier of the “Voice-Gateway” device (202);
Step 7: the interconnection router device (500) initiates call set-up procedure towards the “Voice-Gateway” device (202); said procedure conforms to the standard Session Initiation Protocol (SIP);
Step 8: after step 7, the “Voice-Gateway” device (202) initiates call set-up procedure towards mobile communication means (102); the call signalling between the switching centres of the local cell network (602) and the “Voice-Gateway” device (202) conforms to the standard “ISDN User Part” (ISUP);
at the end of steps 2 and 3, a “voice” communication channel is set up between the mobile communication means (101) and the interconnection router (500) via the “Voice-Gateway” (201); similarly, at the end of steps 7 and 8 a “voice” communication channel is set up between the mobile communication means (102) and the interconnection router (500) via the “Voice-Gateway” (202); the interconnection router device (500) is then able to set up a bridge between the different communication sections to place the communication mobile (101) of the caller in contact with the communication mobile (102) of the called person.

8. The method according to claim 7,
characterized in that the user travelling in a foreign country initiates outgoing call procedure; the outgoing call procedure is managed by the application module (111) of the mobile communication means (101), this procedure called conference calling by [symbol] Call-back SMS [symbol] comprises the following steps:
Steps 1, 2: further to a call initiation command entered by the caller user, the controller of the application module (111) changes to “Call” status (123) to verify the call management policies to be applied;
Step 3: the controller of the application module sends an instruction command by SMS, comprising the number of the called person with his international area code, to the “SMS-Gateway” device (301);
Step 4: the “SMS-Gateway” device (301) initiates call set-up procedure towards the interconnection routing device (500); according to one example of implementation, said procedure conforms to the standard “HyperText Transfer Protocol” (HTTP); the header of the http GET (or http POST) procedure contains the MSISDN-Current of the caller and the MSISDN of the called person;
Step 5: the interconnection routing device (500) polls the Contact part (521) of the database (501) to obtain the current location (United States) and the “MSISDN-Current” telephone identifier of the called person;
Step 6: the interconnection router device (500) polls the Country part (531) of the database (501) to obtain the telephone identifier of the “SMS-Gateway” device (302);
Step 7: the interconnection routing device (500) opens a conference calling session; it initiates call back procedure towards the “Voice-Gateway” device (201);
Step 8: the “Voice-Gateway” device (201) uses the received MSISDN number to locate the GMSC (Gateway Mobile Switching Centre) of the mobile network of the caller (101); once the GSMC is identified, an “IAM” signal “(Initial Address Message”) is relayed to the latter;
Step 9: the MSC/VLR (Mobile Switching Centre/Visiting Location Register) of the cell network (601) which currently controls the cell telephone (101) of the receiving caller verifies that the called number is indeed included in its routing tables and calls back the caller (101);
Step 10: after step 9, a communication channel is set up between the interconnection routing device (500) and the mobile telephone (101); a waiting message can be sent to the caller;
Steps 11, 12, 13: these are identical to the corresponding steps 7, 8, 9: after step 13, a communication channel is set up between the interconnection routing device (500) and the mobile telephone (10);
Step 15: the GMSC of the cell network (602) sends back to the “Voice-Gateway” device (202) an “ACM” message (“Address Complete Message”) to inform the device (202) that a circuit has been reserved;
Steps 16 to 19: after step 15, the “Voice-Gateway” device (202) sends back to the interconnection router (500) a SIP message of “Ringing” type; this message is relayed by all the network elements concerned so that the caller is able to hear the “free” tone coming from the mobile telephone (102) of the called person;
Step 21: after answering by the mobile telephone (102) the GMSC of the cell network (602) sends back to the “Voice-Gateway” device (202) an “ANM” message (“ANswer Message”) to inform the device (202) that the called person has answered;
Steps 22 to 25: after step 21, the “Voice-Gateway” device (202) sends back to the interconnection router (500) a SIP message of “OK” type; this message is relayed by all the network elements concerned so that direct connection is able to be set up between the caller and the called person.

9. The method according to claim 7,
characterized in that the call management policies set up under the control of the application module (111, 112) or of the interconnection router device (500) translate as the implementation of the following steps:
Step A: the application module reads the current value of the MCC stored in a specific memory region; this value had been obtained previously from the radio link between the mobile communication means (101) and the cell network (601) to which it is attached; hereafter this value is called “MCC_Radio”;
Step B: the application module reads a second current value of the MCC stored in a specific memory region; this value had been obtained previously from one of the IMSIs of the Multi-IMSI SIM card inserted in the mobile communication means (101); hereafter this value is called “MCC_IMSI”.
Step C: the values “MCC_Radio” and “MCC-IMSI” are compared; if they are different, the physical location of the user and the “logical” location (in the meaning of the GSM/UMTS network) are different; in this case, call procedure of “conference calling” type is initiated; on the other hand, if the values “MCC_Radio” and “MCC_IMSI” are identical, step D is performed;
Step D: the application module (111) verifies whether the value of “MCC_Radio” corresponds to the user's home country; it is important to note that with a Multi-IMSI SIM the user has several “Home countries”: in this case several physical locations of the user can correspond to as many “logical locations” of the mobile communication means (101); if the value of “MCC_Radio” corresponds to one of the home countries of the user, call procedure of “direct call” type is initiated; if not, call procedure of “conference calling” type is initiated.

10. The method according to claim 4,
characterized in that the procedure for adapting the “Presence” procedure to the CAMEL platform, and in particular to the short signalling method of USSD type, comprises the following steps:
Steps 1 to 7: these are identical to the previously defined corresponding steps;
Step 8: further to a user command, the application module (111) makes a call using USSD syntax: *ABC* Body part, in which *ABC* is the USSD service code defined in the CAMEL platform, this code corresponding to the “Presence” procedure; and the Body Part comprising the current telephone identifier of the Multi-IMSI SIM card and the description of the user's physical location, the request for USSD service is relayed from the HLR (611) to the gsmSCF (800) included in the SCP (800);
Step 9: via a http request, the SCP device (800) initiates a “Presence” request to the interconnection router (500);
Step 10: the interconnection router (500) and its database (501) record the location data;
Step 11: via a http request, the interconnection router (50) sends back a reply to the SCP device (800);
Step 12: in turn, the SCP device (800) sends back to the application module (111) a reply using USSD syntax: *ABC* Body part, Body part comprising the telephone identifier of the local SIM card and the parameters needed by the application module (111) of the mobile communication means (101) to record the physical and logical location data.

11. The method according to claim 8,
characterized in that the adapting of the “Call-back SMS” procedure, using “Call-back USSD” procedure, results in the implementing of the following steps:
Step 1: further to a call initiation command entered by the caller user, the controller of the application module (111) changes to “Call” status (123) to verify the call management policies to be applied;
Step 2: the application module (111) sends a call request using USSD syntax: *XYZ* Body part in which *XYZ* is the USSD service code defined in the CAMEL platform, this code corresponding to a “Call-back USSD” procedure, and the Body part comprising the number of the called person with his international area code;
Step 3: the SCP device (800) initiates call set-up procedure towards the interconnection router device (500), according to one example of implementation said procedure conforms to the standard “HyperText Transfer Protocol” (HTTP); the header of the http GET (or http POST) procedure will contain the MSISDN-Current of the caller and the MSISDN of the called person;
Step 4: the interconnection router device (500) polls the Contact part (521) of the database (501) to obtain the current location and the “MSISDN-Current” telephone identifier of the called person;
the following steps 5-25 are as previously defined.
